(19) United States
(12) Patent Application Publication
(10) Pub. No.: US 2015/0118053 A1
(43) Pub. Date: Apr. 30, 2015

(54) HIGH EFFICIENCY VERTICAL AXIS WIND TURBINE APPARATUS

(71) Applicant: ABUNDANT ENERGY, LLC, Austin, TX (US)

(72) Inventors: DOUGLAS W. BURNS, AUSTIN, TX (US); ALLEN WILLISTON, FORISTELL, MO (US); TYLER N. DOYLE, MARBLEHEAD, MA (US)

(73) Assignee: ABUNDANT ENERGY, LLC, Austin, TX (US)

(21) Appl. No.: 14/062,980

(22) Filed: Oct. 25, 2013

(51) Int. Cl. F03D 9/00

(52) U.S. Cl. CPC F03D 9/002
USPC 416/146 R

(57) ABSTRACT

A high efficiency vertical axis wind turbine apparatus for generating energy from wind power. The apparatus includes a generator in communication with a rotatable shaft, wherein the rotatable shaft is disposed along a central axis. A support bearing is coupled to the rotatable shaft for rotatably supporting the rotatable shaft. A plurality of substantially similar symmetrical wings is connected to and extends from the rotatable shaft wherein each wing provides an upper strut, a blade, and a lower strut. The upper strut has a substantially curvilinear configuration and is connected to the rotatable shaft and the blade. The blade has a substantially straight linear configuration substantially parallel to the central axis. The lower strut has a substantially curvilinear configuration and is connected to the rotatable shaft and the blade such that the wings are rotatably driven by wind so as to rotate the rotatable shaft and drive the generator.

### FIELD OF THE INVENTION

The present invention relates to a high efficiency vertical axis wind turbine apparatus, and more particularly, a vertical axis wind turbine apparatus that enhances its efficiency through its structural design while also reducing the amount of wind necessary to self-start the vertical axis wind turbine apparatus.

### BACKGROUND OF THE INVENTION

In today's global environment, the world has become increasingly aware of the effects of global climate change purported to be caused by the burning and exhaustion of certain fuels, such as fossil fuels. Renewable energy is a solution, or at least a mitigating factor, in resolving global climate change. Wind power is a form of renewable energy that is clean, low in greenhouse gas emissions, and truly renewable. Thus, many of the world's countries, especially the western countries, have launched the development and application of wind power generators.

Wind power generating systems utilize wind turbines that are caused to rotate by the wind. The wind turbines are typically connected to an output shaft which in turn drives a motor/generator that converts the mechanical torque of the output shaft to electrical power.

Wind turbines are divided into vertical axis wind turbines and horizontal axis wind turbines. Vertical axis wind turbines are wind turbines that rotate about a vertically oriented axis that is perpendicular to the wind direction and are not commonly required to be oriented to the direction of the wind flow, while horizontal axis wind turbines have wind turbines that rotate about a horizontally oriented axis that is parallel to the direction of the wind and must have some means of being oriented to the direction of the wind flow, either actively or passively. It is purported that vertical axis wind turbines have advantages over conventional horizontal axis wind turbines such as more advanced machining design, lower manufacturing costs, lower threshold wind speed, lower noise, easier maintainability, less light pollution and aesthetically more pleasing. In addition, vertical axis wind turbines are advantageous in that they are omnidirectional and do not need to be turned into the wind like horizontal axis wind turbines. Therefore, vertical axis wind turbines have great potential in both commercial and residential applications.

Vertical axis wind turbines tend to come in two main configurations: downwind (e.g. “Savonius”) and upwind (e.g. “Darrieus” or “H-Type”) vertical axis wind turbines. In the case of the Savonius wind turbine, power is generated using momentum transfer (a drag device), whereas the Darrieus device uses aerodynamic forces (the lift force on an airfoil) to generate torque. The Savonius device is characterized by its high torque, low speed and low efficiency. The Darrieus rotor is characterized by its high speed and high efficiency.

The Darrieus vertical axis wind turbine is a high efficiency design whose aerodynamic efficiency approaches the Betz limit, which is the theory that no turbine can capture more than 59.3% of the kinetic energy in wind. All of its heavy equipment, such as the generator, is stationary and located below the main turbine components making them easier to access and maintain. The lighter structural designs of the vertical axis wind turbine blades may lead to large flexures (both static and dynamic) of the blade. In many cases, the blades must be reinforced using struts. While struts provide the necessary stability at minimal capital cost, they may cause a significant reduction in rotor performance by introducing aerodynamic drag at the strut-to-blade joints and drag producing vortices at the ends of the blades thereby reducing the efficiency of the vertical axis wind turbine.

Another disadvantage to the Darrieus wind axis turbine is that they may not self-start, depending upon the wind conditions. Thus, to ensure that a vertical axis wind turbine starts when desired, the turbine may be equipped with a starting system. Typically, this starting system uses either a separate motor or a means for using a generator as a motor to rotate the rotor until it has reached sufficient speed to start producing power. Although this is a relatively simple solution to the need for a starting system, it imposes the requirement that an additional motor be included, thereby increasing the capital cost of the turbine. The alternative to such a starting system is to allow the wind turbine to start upon a sufficient amount of wind. Unfortunately, such starting winds typically must be in the area of 12-15 miles per hour which may not occur on a regular basis.

Another concern with the vertical axis wind turbine is that the blades produce positive torque when they cross the wind and produce little or negative torque when they move parallel to the wind. Thus, each vertical axis wind turbine blade produces two “pulses” of torque in each revolution. In even numbered bladed vertical axis wind turbines and, in particular, two bladed vertical axis wind turbines, these pulses align, producing a highly variable output torque that approaches a sinusoid with a positive mean. Not only is the magnitude of the torque pulses important to the performance of the vertical axis wind turbine, but the shape of the torque pulses is important as well. For instance, vertical axis wind turbines having poorly shaped airfoils will create abrupt torque pulses, whereas properly shaped airfoils will gradually build and release lift by producing a longer torque pulse that is better able to blend with the torque pulse before and after it. Since the generator and bearings do not operate well with a highly varying torque, the vertical axis wind turbine powertrain can be problematic, as such high varying torques may affect the performance and the life of the generator and the bearings.

It would be desirable to provide a vertical axis wind turbine that provided high aerodynamic efficiencies while also providing a more compatible self-starting system and a low varying torque on the powertrain.

### SUMMARY OF THE INVENTION

The present invention provides a high efficiency vertical axis wind turbine apparatus for generating renewable energy from the wind. The vertical axis wind turbine apparatus of the present invention provides a generator that is in communication with a rotatable shaft disposed along a central axis of the vertical axis wind turbine apparatus. A support bearing is coupled to the rotatable shaft for supporting the rotation of the rotatable shaft. A plurality of substantially similar and symmetrical wings are connected to and extend from the rotatable shaft wherein each of the wings provide a top strut, a blade, and a bottom strut. The top strut has a substantially curvilinear configuration having a first end and a second end wherein the first end is connected to the rotatable shaft, and the second end is connected to the blade. The blade has a substantially straight linear configuration substantially parallel to the central axis of the vertical axis wind turbine apparatus. The bottom strut has a substantially curvilinear configuration having a first end and a second end wherein the first end is connected to the rotatable shaft, and the second end is connected to the blade such that the plurality of wings are rotatably driven by wind so as to rotate the rotatable shaft and drive the generator.

The top strut, the blade, and the bottom strut of each wing of the present invention have an airfoil cross-sectional configuration. The blade is angled away from the rotatable shaft at a substantially 1° degree angle.

The plurality of wings of the vertical axis wind turbine apparatus of the present invention may comprise four wings symmetrically spaced about the rotatable shaft. Each wing may have a winglet extending from and connected to one end of the blade adjacent the second end of the bottom strut. The winglet may extend away from the rotatable shaft and may also have a substantially linear configuration or a substantially curvilinear configuration. Each winglet may also have an airfoil cross-sectional configuration.

The vertical axis wind turbine apparatus of the present invention may also provide at least one support member connected to and extending between each of the blades and the rotatable shaft. Each of the at least one support member may have an airfoil cross-sectional configuration and may be fabricated from a carbon fiber material. The present invention may also provide at least one support member that is connected to and extends between the upper struts of the wings and at least one support member that is connected to and extends between the lower struts of the wings. The at least one support member connected between the upper and lower struts may be fabricated from a metallic cable.

The present invention may also provide an enclosure for housing the generator wherein the enclosure has a sliding member for supporting the generator such that the sliding member can slide in and out of the enclosure to provide access for maintaining the generator.

The top strut, the blade, and the bottom strut of the wings of the vertical axis wind turbine of the present invention may each be fabricated from a carbon fiber material.

### BRIEF DESCRIPTION OF THE DRAWINGS

The embodiments of the present invention will be readily understood by the accompanying drawings and detailed descriptions, wherein:

FIG. 1 is a perspective drawing of the high efficiency vertical axis wind turbine apparatus of the present invention;

FIG. 2 is a front view of the wings of the high efficiency vertical axis wind turbine apparatus of the present invention;

FIG. 3A is a perspective view of the upper struts and the rotatable shaft of the high efficiency vertical axis wind turbine apparatus of the present invention;

FIG. 3B is a sectional view of the upper struts and rotatable shaft of the high efficiency vertical axis wind turbine apparatus of the present invention;

FIG. 4 is a perspective view of the support bearing of the high efficiency vertical axis wind turbine apparatus of the present invention;

FIG. 5 is a sectional view of the support bearing of the high efficiency vertical axis wind turbine apparatus of the present invention;

FIG. 6A is a front view of a blade of the high efficiency vertical axis wind turbine apparatus of the present invention;

FIG. 6B is a sectional view of a blade of the high efficiency vertical axis wind turbine apparatus of the present invention;

FIG. 7A is a perspective view of the upper strut of the high efficiency vertical axis wind turbine apparatus of the present invention;

FIG. 7B is a side view of the upper strut of the high efficiency vertical axis wind turbine apparatus of the present invention;

FIG. 7C is a sectional view of the upper strut of the high efficiency vertical axis wind turbine apparatus of the present invention;

FIG. 8A is a perspective view of the lower strut of the high efficiency vertical axis wind turbine apparatus of the present invention;

FIG. 8B is a side view of the lower strut of the high efficiency vertical axis wind turbine apparatus of the present invention;

FIG. 8C is a sectional view of the lower strut of the high efficiency vertical axis wind turbine apparatus of the present invention;

FIG. 9 is a perspective view of the winglet of the high efficiency vertical axis wind turbine apparatus of the present invention;

FIG. 10 is a perspective view of the generator housed within the enclosure of the high efficiency vertical axis wind turbine apparatus of the present invention;

FIG. 11 is a perspective view of the generator outside the enclosure of the high efficiency vertical axis wind turbine apparatus of the present invention;

FIG. 12 is a graph showing the torque coefficients of the high efficiency vertical axis wind turbine apparatus of the present invention having three wings and four wings;

FIG. 13 is a perspective view of the vertical axis wind turbine apparatus of the present invention showing the enclosure for the generator mounted adjacent the support bearing; and

FIG. 14 is a top plan view of the vertical axis wind turbine apparatus of the present invention showing the primary and secondary torque power bands.

### DETAILED DESCRIPTION OF THE PREFERRED EMBODIMENT

The present invention relates to a high efficiency vertical axis wind turbine apparatus for generating energy through the use of wind power. The vertical axis wind turbine apparatus of the present invention provides a Darrieus configuration having a higher aerodynamic efficiency than conventional vertical axis wind turbines through its unique structure and shape. In addition, the innate structure of the vertical axis wind turbine apparatus of the present invention reduces torque variation and vibration thereby reducing stress and forces applied to the bearing and the generator. The present invention also provides a vertical axis wind turbine apparatus which will self-start at lower wind speeds than conventional vertical axis wind turbines.

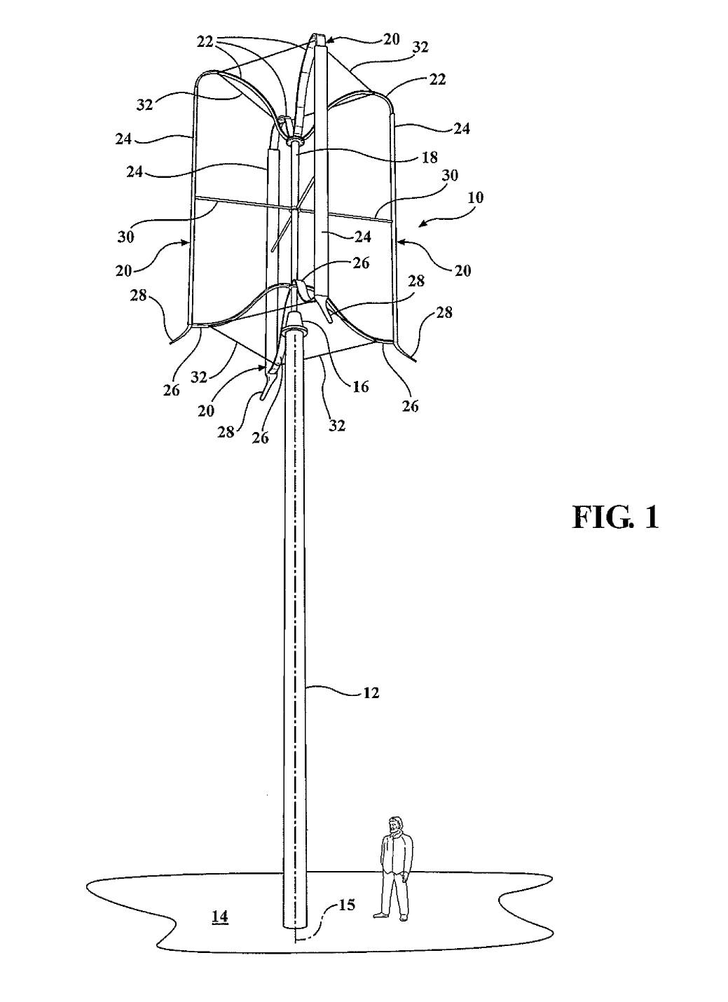

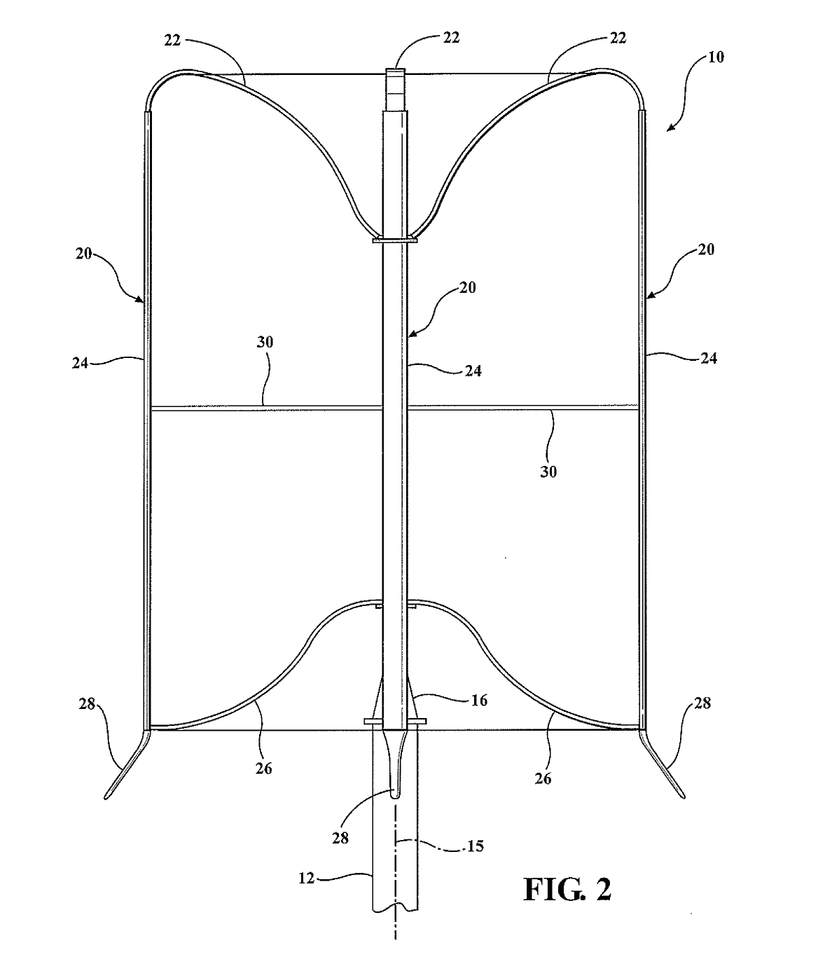

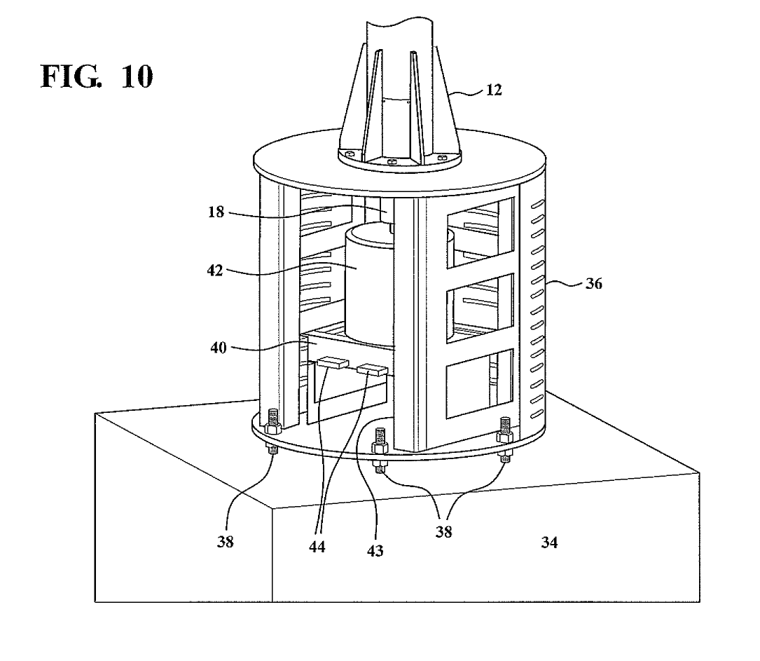

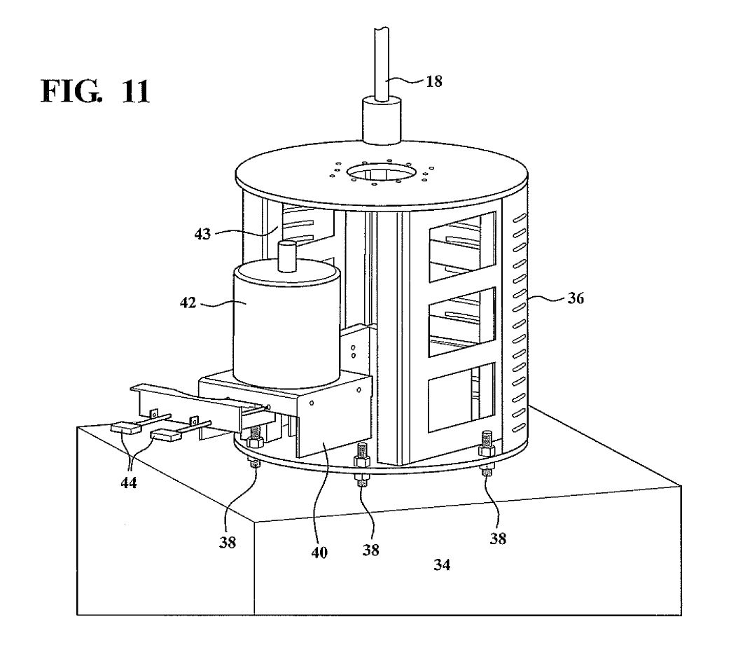

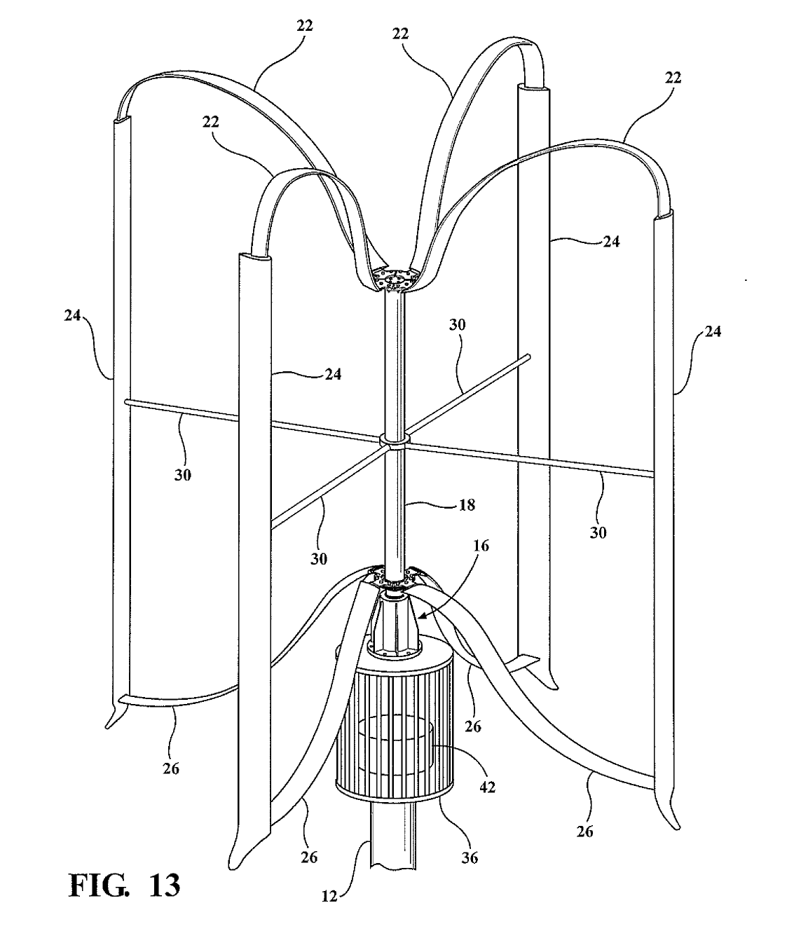

As seen in FIGS. 1-14, a vertical axis wind turbine apparatus 10 of the present invention provides a structural design having numerous benefits over previous conventional designs including a higher aerodynamic efficiency. As seen in FIG. 1, the vertical axis wind turbine apparatus 10 of the present invention provides an elongated, rigid pole 12 that is supported by a substructure, such as the ground 14. The elongated pole 12 extends vertically upward along a vertical or central axis 15 of the vertical axis wind turbine apparatus 10 and may extend to varying heights depending on the application and the environment. The present invention is not limited to the elongated pole 12 being the only support structure for the vertical axis wind turbine apparatus 10, but rather, a number of different support structures or towers, such as lattice structures, may be utilized. The elongated pole 12 supports a support bearing 16 which receives and rotatably supports a rotatable shaft 18 which may extend through and beyond the elongated pole 12. Both the elongated pole 12 and the rotatable shaft 18 are fabricated from a high strength, rigid material, such as steel. The vertical axis wind turbine apparatus 10 of the present invention provides four wings 20 that are connected to and extend from the rotatable shaft 18, as seen in FIGS. 1-2. The wings 20 are substantially similar in structure and are symmetrically spaced evenly about the rotatable shaft 18. Each wing 20 provides an upper strut 22, a blade 24, and a lower strut 26. A winglet 28 may be connected to and extend away from a bottom end of the blade 24. A first set of support members 30 may extend between the rotatable shaft 18 and the blades 24, and a second set of support members 32 may be connected to and between the upper struts 22 and to and between the lower struts 26 of the wings 20. The wings 20 of the vertical axis wind turbine apparatus 10 are designed to rotate in response to air moving across and through the wings 20 of the vertical axis wind turbine apparatus 10 thereby driving the rotation of the rotatable shaft 18. The rotatable shaft 18, in turn, drives rotation of a generator 42 mounted at the base of the pole 12, as seen in FIGS. 10-11, or mounted adjacent the support bearing 16 near the top of the pole 12, as seen in FIG. 13. Power is then transferred from the generator 42 by conventional means whereby it may be utilized in a commercial or residential application.

In order to support the vertical axis wind turbine apparatus 10 of the present invention in a vertical orientation, the elongated pole 12 is supported by a substructure, such as the ground 14, as seen in FIG. 1. However, the substructure may also comprise a block of cement 34, as seen in FIGS. 10 and 11, located at or near the ground wherein an enclosure 36 may be mounted to the cement 34 through conventional fasteners 38. The enclosure 36 has a substantially cylindrical configuration fabricated from a high strength material such as steel and having a sliding shelf 40 mounted therein. The shelf 40 supports the generator 42 wherein the shelf 40 has the ability to slide in and out of the enclosure 36 through an opening 43 provided in the enclosure 36. In the alternative, the generator 42 may be mounted to a rigid, stationary base plate (not shown) located on the bottom of the enclosure 36. A door (not shown) may be hinged to the enclosure 36 for opening and closing the opening 43 in the enclosure 36. In the case of the sliding shelf 40, a pair of pins 44 provides a means in which to lock and unlock the sliding shelf 40 in the enclosure 36. When the pins 44 are inserted into the shelf 40, as seen in FIG. 10, the shelf 40 is locked in place within the enclosure 36 thereby assuring the position of the generator 42 within the enclosure 36. When the pins 44 are pulled outward from the shelf 40, the shelf 40 is unlocked from its position in the enclosure 36, and the shelf 40 can be pulled outward from the enclosure 36 by pulling the pins 44, as seen in FIG. 11. When the shelf 40 is locked within the enclosure 36, as seen in FIG. 10, the end of the rotatable shaft 18 is inserted through the end of the enclosure 36 and coupled to the generator 42 so that the rotatable shaft 18 can drive the generator 42 when the shaft 18 is rotated. The end of the elongated pole 12 is connected to the end of the enclosure 36 and receives and encompasses the rotatable shaft 18 in a substantially coaxial manner. When the vertical axis wind turbine apparatus 10 is mounted relatively low to the ground, the rotatable shaft 18 may be relatively short, and thus, the enclosure 36 and the generator 42 may be located at the base of the pole 12, as seen in FIGS. 10-11. However, when the vertical axis wind turbine apparatus 10 is mounted relatively high from the ground, the rotatable shaft 18 becomes too long to effectively mount the generator 42 at the base of the pole 12, and thus, the enclosure 36 and generator 42 are mounted below the support bearing 16 near the top of the pole 12, as seen in FIG. 13. Although not shown, the generator 42 may be coupled to a conventional means of transferring the power from the generator 42 regardless of where the generator 42 is positioned.

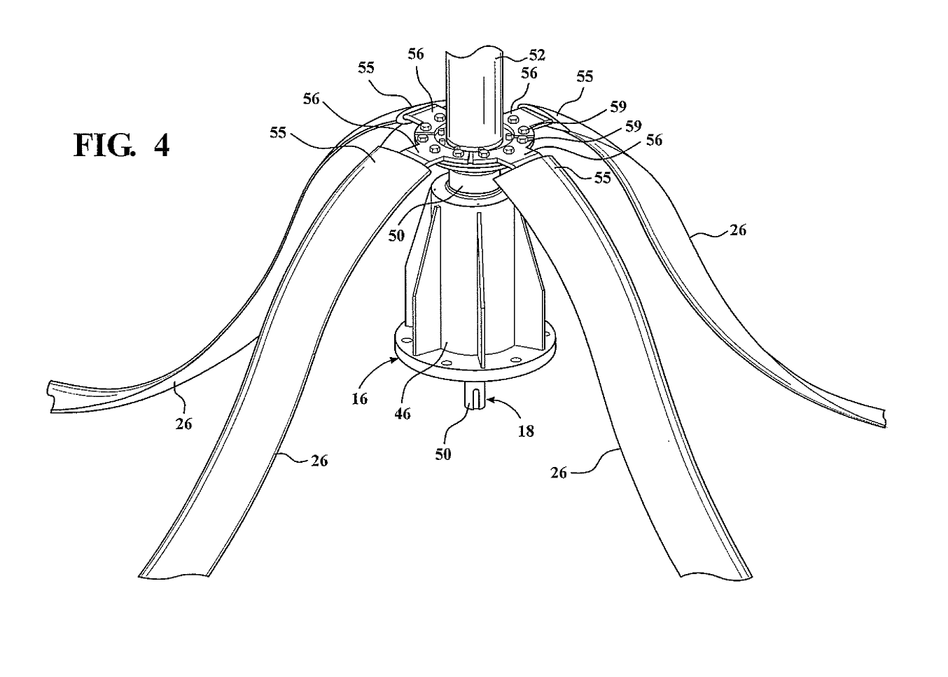

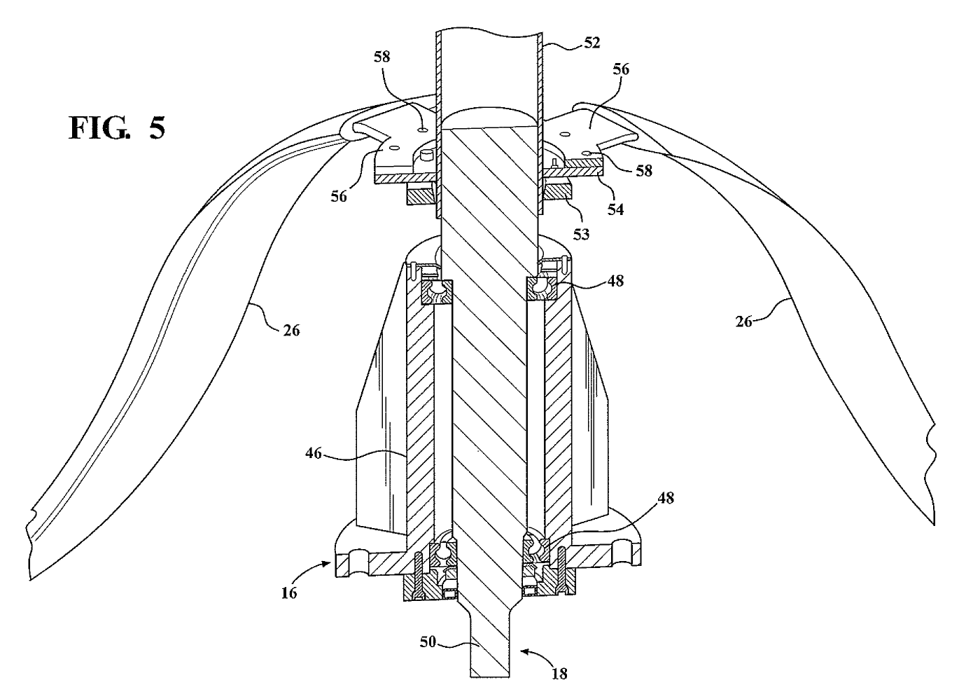

When the generator 42 is mounted at the base of the pole 12, the elongated pole 12 extends upward from the enclosure 36, and the elongated pole 12 encompasses and protects the rotatable shaft 18 in a substantially coaxial manner, as previously described. If the generator 42 is mounted adjacent the support bearing 16, then the rotatable shaft 18 may start from the generator 42 and extend upward to the wings 20. In order to support the rotation of the rotatable shaft 18, the support bearing 16 is supported at and connected to the end of the elongated pole 12 when the generator 42 is mounted at the base of the pole 12, as seen in FIG. 1. When the generator 42 is mounted at the top of the pole 12, the support bearing 16 is mounted to the top of the enclosure 42, as seen in FIG. 13. Either way, the support bearing 16 receives and rotatably supports the rotatable shaft 18, as seen in FIGS. 4-5. The support bearing 16 has a substantially cylindrical housing 46 having roller bearings 48 mounted within each end of the housing 46 adjacent the rotatable shaft 18 for supporting the rotation of the rotatable shaft 18. The support bearing 16 is a dedicated bearing as compared to certain conventional designs which mount the bearings in the generator. The dedicated support bearing 16 lasts longer than previously known generator bearings and can be easily removed and replaced by sliding the dedicated bearing 16 off the rotatable shaft 18. The bottom of the housing 46 of the support bearing 16 is connected to the end of the elongated pole 12 or the enclosure 36 through the use of conventional fasteners (not shown).

In order to rotate the rotatable shaft 18, the rotatable shaft 18 may have an inner core 50 and an outer shell 52 that are integrally connected by conventional means, such as adhesives, wherein the inner core 50 and the outer shell 52 rotate simultaneously, as seen in FIG. 5. The rotatable shaft 18 is rotatably driven by the wings 20 of the vertical axis wind turbine apparatus 10 being driven by the wind. A first end 55 of the lower strut 26 of each of the wings 20 is connected to the outer shell 52 of the rotatable shaft 18 just above the support bearing 16, as seen in FIGS. 4 and 5. A substantially cylindrical clamp 53 and a mounting plate 54 are connected and mounted to the outer shell 52 of the rotatable shaft 18 just above the support bearing 16. The clamp 53 applies inward pressure to the outer shell 52 of the rotatable shaft 18 where the outer shell 52 and the inner core 50 of the rotatable shaft 18 overlap and are connected. Each of the lower struts 26 has a substantially similar mounting tab 56 that is integrally connected to the mounting tab 56. The mounting tabs 56 may be fabricated from a light-weight, high strength material, such as aluminum, and may be connected to the lower struts 26 by molding the lower struts 26 onto the mounting tabs 56 or by using other conventional attachment means, such as adhesives, connectors, fasteners, etc. The mounting tabs 56 have apertures 58 extending there through such that the apertures 58 in the mounting tabs 56 align with corresponding apertures (not shown) in the mounting plate 54. Conventional fasteners (not shown) extend through the corresponding apertures 58 to connect the mounting tabs 56 to the mounting plate 54. The mounting tabs 56 of the lower struts 26 are symmetrically positioned and evenly spaced about the rotating shaft 18 so as to symmetrically space the lower struts 26 of the wings 20 about the rotatable shaft 18. The mounting tabs 56 are angled to provide the lower struts 26 with the appropriate angle leading away from the rotatable shaft 18.

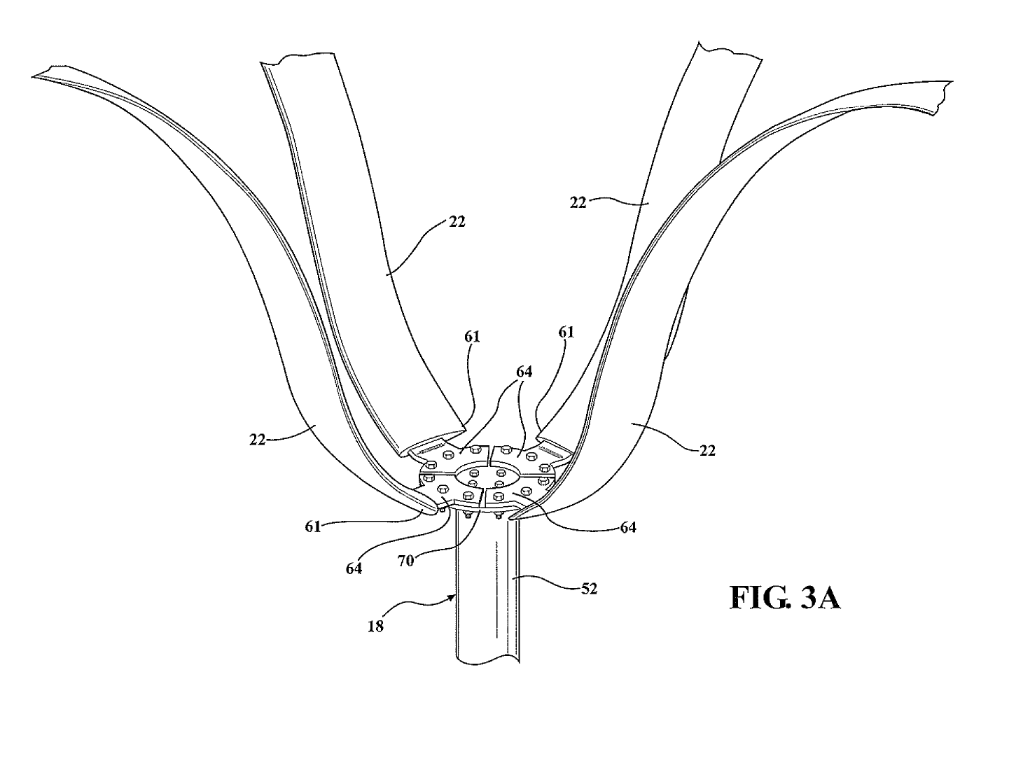

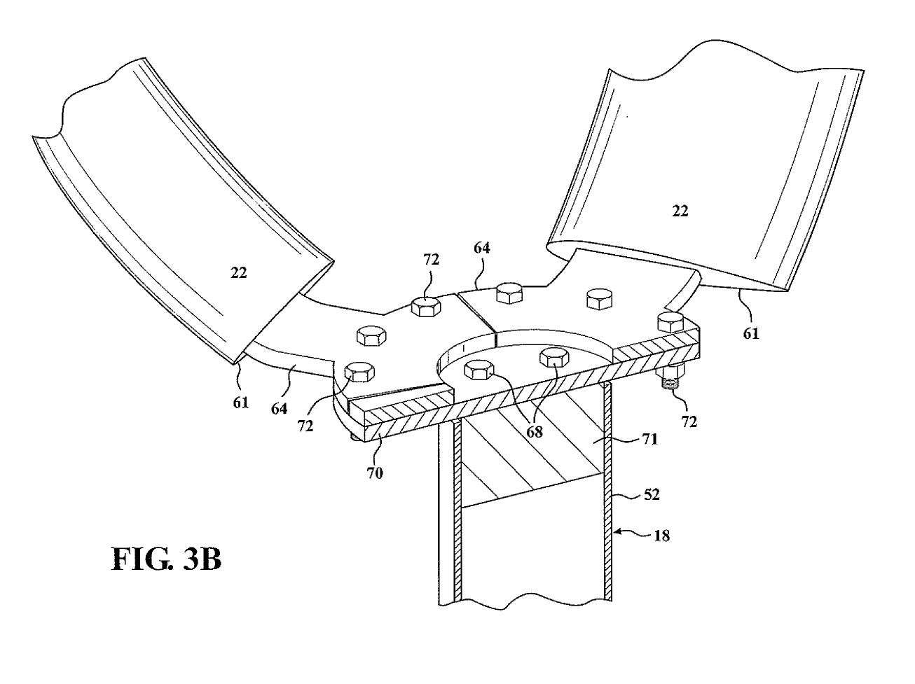

To connect the upper struts 22 of the wings 20 to the rotatable shaft 18, a first end 61 of the upper struts 22 is connected to the rotatable shaft 18 in a similar fashion as the lower struts 26, as explained above. As seen in FIGS. 3A-3B, each of the upper struts 22 have a substantially similar mounting tab 64 that is substantially similar to the mounting tabs 56 of the lower struts 26 wherein the mounting tabs 64 are fabricated from a light-weight, high strength material such as aluminum. The mounting tabs 64 are integrally connected to the ends of the upper struts 22 wherein the mounting tabs 64 may be connected to the upper struts 22 by molding the upper struts 22 to the mounting tabs 64 or by connecting the mounting tabs 64 to the upper struts 22 through conventional attachment means, such as adhesives, fasteners, connectors, etc. The mounting tabs 64 have apertures (not shown) extending there through and correspondingly align with apertures (not shown) provided in a substantially circular mounting plate 70 connected to a small inner core portion 71 of the rotatable shaft 18 by conventional fasteners 68. The small inner core portion 71 is connected to the outer shell 52 of the rotatable shaft 18 in the same manner as the inner core 50 and the outer shell 52 of the rotatable shaft 18, as previously described. Conventional fasteners 72 are inserted through the corresponding apertures in order to secure the mounting tabs 64 to the mounting plate 70. The mounting tabs 64 are mounted to the mounting plate 70 in a substantially symmetrical and evenly spaced manner such that the upper struts 22 of the wings 20 are symmetrically and evenly spaced while properly aligning the lower struts 26 of the wings 20. The mounting tabs 64 are angled to provide the upper struts 22 with the proper angle extending away from the rotatable shaft 18.

In order to minimize and negate the drag producing vortices created on a first end 75 of the blades 24, the upper struts 22 of the wings 20 provide a substantially arcuate or curvilinear configuration, as shown in FIGS. 7A-7C, that minimizes and negates the drag producing vortices created on the end of the blades 24 while connecting the blades 24 to the rotatable shaft 18. The upper struts 22 may fabricated from a carbon fiber material so as to reduce weight while still providing a high degree of strength to the upper struts 22. The upper struts 22 extend upward and outward from the rotatable shaft 18, and each upper strut 22 has a second end 73 that is integrally connected to the first end 75 of each of the blades 24. The upper struts 22 have an airfoil cross-section, as shown in FIG. 7C, wherein a wider or “nose” end 77 of the airfoil cross-section is directed into the wind. The airfoil configuration allows for lift to be created on the upper struts 22 thereby creating torque on the rotatable shaft 18. Since the wings 20 rotate, the upper struts 22 provide torque when rotating with the wind but create drag when rotating against the wind. Due to the configuration of the upper struts 22, the difference between the torque generated with the wind and the drag created against the wind from the upper struts 22 is negligible. However, the upper struts 22 primary aerodynamic benefit is to minimize and negate the drag producing vortices that occur at the first end 75 of the blades 24. This is an improvement over previous conventional designs wherein the ends of the blades are not connected to struts, or the struts are straight and symmetric thereby creating an overall drag to the vertical axis wind turbine caused by the drag producing vortices over the ends of the blades.

To minimize and negate the drag producing vortices created on a second end 79 of the blades 24, the lower struts 26 have a substantially S-shaped configuration that extends away from the rotatable shaft 18 and downward from the upper struts 22, as seen in FIGS. 8A-8C. A second end 81 of the lower struts 26 is connected to the second end 79 of the blades 24 for negating or minimizing the drag producing vortices created on the second end 79 of the blades 24 while connecting the second end 79 of the blades 24 to the rotatable shaft 18. The lower struts 26 are also fabricated from a carbon fiber material such that the lower struts 26 are light in weight while also having a high degree of strength. The lower struts 26 also have an airfoil cross-section, as shown in FIG. 8C, wherein the airfoil configuration provides lift and torque to the rotatable shaft 18 upon the application of wind over a wider or “nose” end 83 of the airfoil configuration of the lower struts 26. As in the upper struts 22, the airfoil configuration of the lower struts 26 provide torque to the rotatable shaft 18 when rotating with the wind, but when the lower struts 26 rotate against the wind, drag is created. However, the overall efficiency of the lower struts 26 turning with and into the wind is negligible, but the primary aerodynamic benefit of the lower struts 26 is to minimize and negate the drag producing vortices that are created at the second end 79 of the blades 24. This is an improvement over previous conventional designs wherein the ends of the blades are not connected to struts, or the struts are straight and symmetric thereby creating an overall drag to the vertical axis wind turbine caused by the drag producing vortices on the ends of the blades.

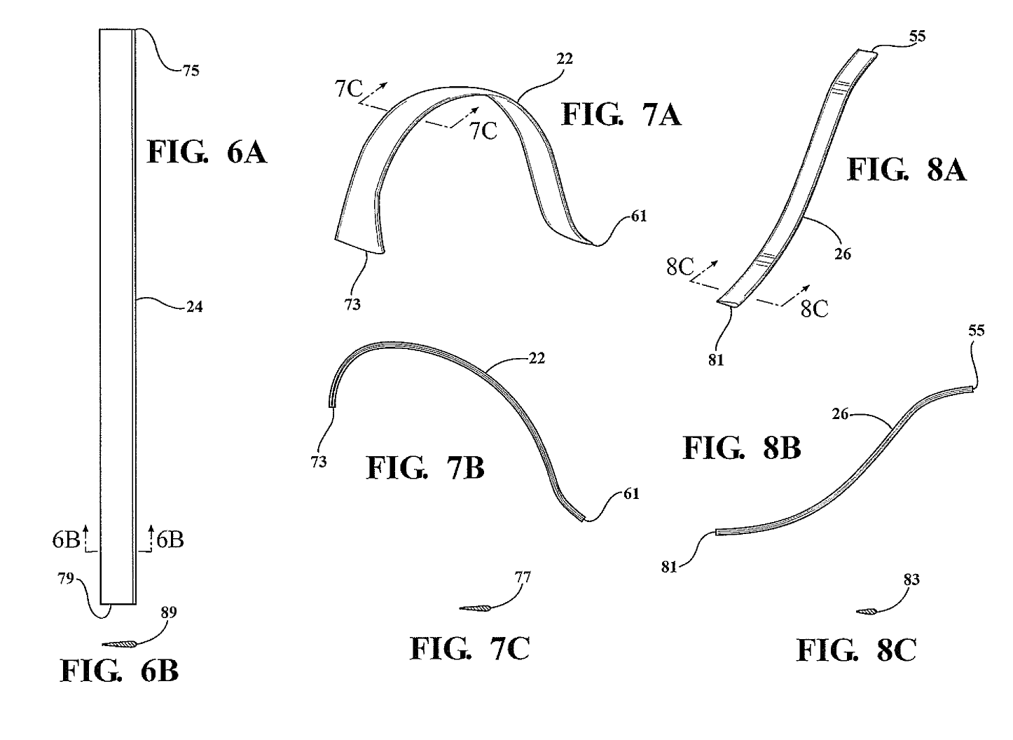

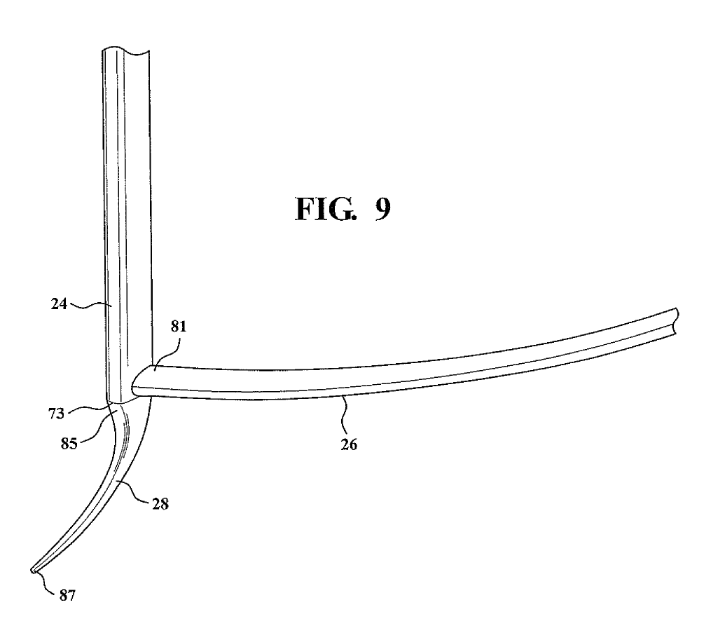

In order to support the upper struts 22 and the lower struts 26, the blades 24 are connected to and extend between the upper struts 22 and the lower struts 26, as seen in FIGS. 1-2, 9, and 13. The blades 24 have a substantially straight configuration, as seen in FIG. 6A, and are may also be fabricated from carbon fiber material in order to provide a lightweight, high strength material. In addition, the blades 24 have an airfoil cross-sectional configuration, as seen in FIG. 6B, wherein lift occurs when the wind passes over a wider or “nose” portion or leading edge 89 of the airfoil configuration. The blade 24 is angled at a small pitch angle, such as substantially 1° degree, away from the central axis 15 of the vertical axis wind turbine apparatus 10 so as to assist in providing torque to the rotatable shaft 18. The 1° degree angle of the blades 24 was found to be the most efficient angle based on experimental results, but other angles may also be efficient with other configurations and/or further testing of the vertical axis wind turbine apparatus 10. The first end 75 of each of the blades 24 are integrally connected to the second end 73 of the upper struts 22 by a conventional attachment means such as adhesives, fasteners, connectors, etc. The second end 73 of the upper strut 22 is generally the same size and shape as the first end 75 of the blade 24 in order to enhance the efficiency of the upper strut 22 to the blade 24 connection, but the upper strut 22 may also have a consistent shape and size throughout the upper strut 22, as shown in FIG. 13, to reduce the manufacturing cost associated with the vertical axis wind turbine apparatus 10. The second end 73 of the blades 24 are connected to the second end 81 of the lower struts 26 in a substantially perpendicular manner, as shown in FIG. 9. The lower struts 26 may be connected to the blades 24 through the use of any conventional attachment means, such as adhesives, fasteners, connectors, etc. It is recommended that the blades 24 be as thin as possible while still maintaining structural integrity in order to enhance the speed of the wings 20 and the rotatable shaft 18.

To minimize and negate the drag producing vortices created at the second end 73 of the blades 24, the winglets 28 are connected to the end of the blades 24 in an integral fashion, as shown in FIG. 9, in order to reduce drag and increase the efficiency. The winglets 28 are also fabricated from a carbon fiber material in order to provide a lightweight, high strength material. One end 85 of the winglets 28 is connected to the second end 73 of the blades 24 by a conventional attachment means, such as adhesive, fasteners, connectors, etc. The winglets 28 extend downward from the blades 24 in a curved fashion by extending away from the rotatable shaft 18. The winglets 28 narrow from the end 85 of the winglet 28 attached to the blades 24 to a free end 87 of the winglets 28. The winglets 28 also have an airfoil cross-section such that the winglets 28 may assist in providing lift to the wings 20 thereby enhancing the efficiency of the vertical axis wind turbine apparatus 10 by minimizing or negating the drag producing vortices created at the second end 73 of the blades 24. It should also be noted that the winglets 28 can adopt a substantially straight configuration, as seen in FIG. 2, wherein the winglets 28 angle away from the blades 24. The winglets 28 having the substantially straight configuration still have an airfoil cross-sectional configuration, thereby minimizing or negating the drag producing vortices created at the second end 73 of the blades 24, but the substantially straight configuration of the winglets 28 can reduce the cost of manufacturing the winglets 28.

In order to provide support to the wings 20 of the vertical axis wind turbine apparatus 10, the support members 30 may be connected to and extend between the blades 24 and the rotatable shaft 18. The support members 30 may have the appearance of small blades having airfoil cross-sections that are fabricated from a carbon fiber material. The air foil cross-sections of the support members 30 provide lift to the wings 20 while also providing structural support and stability to the wings 20. The other support members 32 may be utilized by connecting the support members 32 to and extending between each of the lower struts 26 and/or each of the upper struts 22 of the wings 20 by either extending between adjacent struts 22, 26 or opposing struts 22, 26. The support members 32 may be fabricated from metallic cables. The support members 32 also assist in supporting and stabilizing the wings 20 when rotating about the rotatable shaft 18.

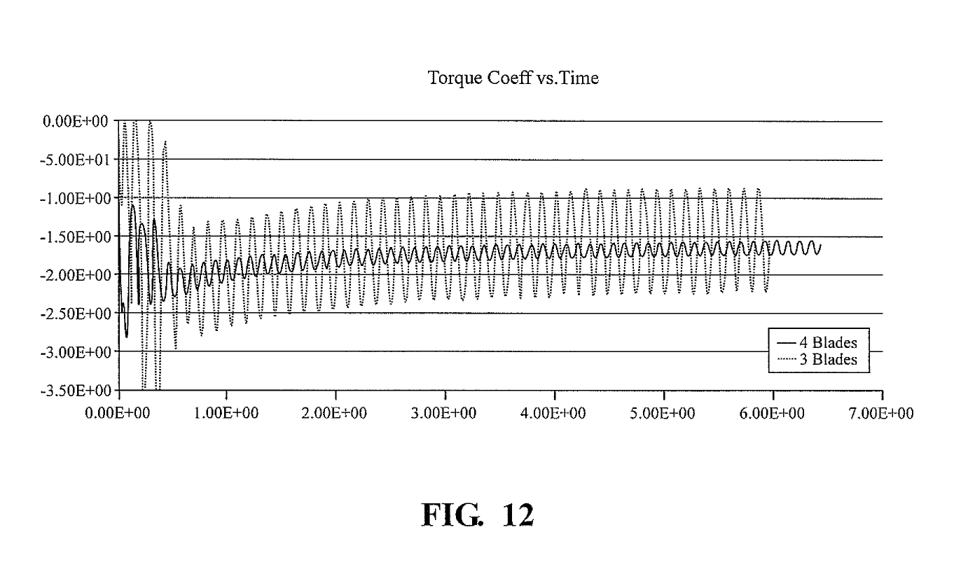

To reduce the amount of torque variation and vibration generated by the wings 20 of the vertical axis wind turbine apparatus 10 and transferred to the rotatable shaft 18 and the generator 42, the vertical axis wind turbine apparatus 10 utilizes four wings 20 as opposed to three. The selection of four wings 20 over three is supported by the graph in FIG. 12. The graph shows the torque coefficient of power on the vertical axis of the graph versus time on the horizontal axis of the graph which relate to the amount of power captured in a given wind regime. The variation of the torque coefficient of power in the graph is due to the amount of power captured, as the vertical axis wind turbine apparatus 10 revolves about the central axis 15. Each pulse corresponds to a wing 20 passing through its highest region of power captured. With a three bladed turbine, there are three pulses per revolution, and in a four bladed turbine, there are four pulses per revolution. These pulses of power directly relate to variations in torque supplied to the rotatable shaft 18 and thus to the generator 42. As the graph shows, the three bladed turbine pulses (red line) have much higher amplitudes than the four blade design (blue line). Therefore, the generator 42 will realize a much smoother power supply from a four wing turbine design as opposed to a three wing turbine design. This is important because the variations in power/torque can be detrimental to the life of the generator 42 and the support bearing 16 and cause constantly changing electrical pulses which are detrimental to other equipment as well. A smoother operation means less vibration in the overall physical structure thereby leading to less physical fatigue stresses as well as a reduction in noise. Although an analysis of five and six bladed turbines showed a slight additional smoothing of the torque pulses, the incremental benefit was fairly small and did not justify the expense of the additional one or two blade assemblies.

In operation, the vertical axis wind turbine apparatus 10 of the present invention is mounted in a vertically upright position, as shown in FIGS. 1 and 13. Due to the configuration of the upper struts 22 and the lower struts 26 of the wings 20, the vertical axis wind turbine apparatus 10 requires less initial startup wind to start the rotation of the wings 20 and the rotatable shaft 18 than other conventional vertical axis wind turbines having fixed blades. The initial startup wind required to start the rotation of the vertical axis wind turbine apparatus 10 will vary depending on the type and size of the generator 42 utilized. The alternative to using the wind to start the vertical axis wind turbine apparatus 10 rotating is to use an initial starting motor to initially start the vertical axis wind turbine rotating which requires additional capital cost and energy.

During the operation of the vertical axis wind turbine apparatus 10, wind passes across the wings 20 of the vertical axis wind turbine apparatus 10 thereby creating lift which generates torque and rotation to the rotatable shaft 18. As seen in FIG. 14, the lift occurs at two locations within the arc of rotation of the vertical axis wind turbine apparatus 10 as noted by the “primary power band” and the “secondary power band”. The direction of the wind and the rotating direction of the vertical axis wind turbine apparatus 10 are also indicated in FIG. 14. In evaluating the efficiency of the vertical axis wind turbine apparatus 10, the ratio of the rotational speed of the blade 12 with respect to the wind speed is considered and is referred to as a “tip-speed ratio” (“TSR”). When the TSR is greater that 1.0:1, the blade 12 always has airflow on its “nose” or leading edge 89 of the blade 24, and any downside vertical axis wind turbine having a TSR greater than 1.0:1 will not have a “drag side” in its rotation. The highest torque produced from the wind is that part of the rotation of the vertical axis wind turbine apparatus 10 where the blade 24 is coming into the wind, because the resultant direction of the airflow on the blade 24 creates lift. The geometry of the airfoil configuration of the blade 24 determines the optimum TSR thereby determining the location of where the greatest lift occurs in the rotation. The optimum TSR of the vertical axis wind turbine apparatus 10 is approximately 3.05:1. Therefore, for the vertical axis wind turbine apparatus 10, there is not a “drag side” of the rotation, but rather, there is only an area of reduced lift which occurs on the back side of the vertical axis wind turbine apparatus 10 where the blade 24 runs with the wind.

Again, due to the air foil configuration of the blades 24, the wind passing over the blades 24 creates lift and torque to the rotatable shaft 18. The configurations and attachment points of the upper struts 22, the lower struts 26, and the winglets 28 to the blades 24 minimize or negate the drag producing vortices on the ends of the blades 24 thereby creating a more efficient vertical axis wind turbine apparatus 10. The air foil configurations of the upper struts 22, the lower struts 26, the winglets 28, and the support members 30 also provide negligible drag or a positive lift to the wings 20 of the vertical axis wind turbine apparatus 10. The rotatable shaft 18 drives the generator 42, and electrical energy is thereby created through wind power.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A vertical axis wind turbine apparatus, comprising:
a generator;
a rotatable shaft in communication with said generator and disposed along a central axis;
a support bearing coupled to said rotatable shaft for supporting the rotation of said rotatable shaft;
a plurality of substantially similar, symmetrical wings connected to and extending from said rotatable shaft wherein each wing provides an upper strut, a blade, and a lower strut;
said upper strut having a substantially curvilinear configuration having a first end and a second end wherein said first end is connected to said rotatable shaft, and said second end is connected to said blade;
said blade having a substantially straight linear configuration substantially parallel to said central axis; and
said lower strut having a substantially curvilinear configuration having a first end and a second end wherein said first end is connected to said rotatable shaft, and said second end is connected to said blade such that said plurality of wings are rotatably driven by wind so as to rotate said rotatable shaft and drive said generator.

2. The apparatus as stated in claim 1, further comprising:
said upper strut, said blade, and said lower strut each having an airfoil cross-sectional configuration.

3. The apparatus as stated in claim 2, further comprising:
said blade angled away from said rotatable shaft at a substantially 1° degree angle.

4. The apparatus as stated in claim 1, wherein said plurality of wings further comprise:
four wings symmetrically and equally spaced about said rotatable shaft.

5. The apparatus as stated in claim 1, further comprising:
each wing having a winglet extending from and connected to one end of said blade adjacent said second end of said lower strut.

6. The apparatus as stated in claim 5, further comprising:
said winglet extending away from said rotatable shaft.

7. The apparatus as stated in claim 5, further comprising:
said winglet having a substantially linear configuration.

8. The apparatus as stated in claim 5, further comprising:
said winglet having a substantially curvilinear configuration.

9. The apparatus as stated in claim 5, further comprising:
said winglet having an airfoil cross-sectional configuration.

10. The apparatus as stated in claim 1, further comprising:
at least one support member connected to and extending between said blade and said rotatable shaft of each of said plurality of wings.

11. The apparatus as stated in claim 10, further comprising:
said at least one support member having an airfoil cross-sectional configuration.

12. The apparatus as stated in claim 11, further comprising:
said at least one support member fabricated from a carbon fiber material.

13. The apparatus as stated in claim 1, further comprising:
at least one support member connected to and extending between said upper strut of said wings; and
at least one support member connected to and extending between said lower strut of said wings.

14. The apparatus as stated in claim 1, further comprising:
said at least one support member fabricated from a metallic cable.

15. The apparatus as stated in claim 1, further comprising:
an enclosure for housing said generator and receiving said rotatable shaft, and said enclosure having a sliding member for supporting said generator, wherein said sliding member can slide in and out of said enclosure to provide access for maintaining said generator.

16. The apparatus as stated in claim 1, further comprising:
said upper strut, said blade, and said lower strut of said wings each being fabricated from a carbon fiber material.

17. A vertical axis wind turbine apparatus, comprising:
a generator;
a rotatable shaft coupled to said generator and disposed along a central axis;
a support bearing coupled to said rotatable shaft for supporting the rotation of said rotatable shaft;
a plurality of substantially similar, symmetrical wings connected to and extending from said rotatable shaft wherein each wing provides an upper strut, a blade, and an upper strut;
said upper strut having a substantially curvilinear configuration and an airfoil cross-sectional configuration having a first end and a second end wherein said first end is connected to said rotatable shaft, and said second end is connected to said blade;
said blade having a substantially straight linear configuration substantially parallel to said central axis and having an airfoil cross-sectional configuration;
said lower strut having a substantially curvilinear configuration having a first end and a second end wherein said first end is connected to said rotatable shaft, and said second end is connected to said blade, and said lower strut having an airfoil cross-sectional configuration; and
each wing having a winglet extending from and connected to one end of said blade such that said plurality of wings are rotatably driven by wind so as to rotate said rotatable shaft and drive said generator.

18. The apparatus as stated in claim 17, further comprising:
at least one support member connected to and extending between said blade and said rotatable shaft wherein said at least one support member has an airfoil configuration.

19. The apparatus as stated in claim 17, further comprising:
said blade angled away from said rotatable shaft at substantially a 1° degree angle.

20. The apparatus as stated in claim 17, further comprising:
an enclosure for housing said generator and receiving said rotatable shaft, and said enclosure having a sliding member for supporting said generator, wherein said sliding member can slide in and out of said enclosure to provide access for maintaining said generator.
